(19) United States
(12) Patent Application Publication
(10) Pub. No.: US 2007/0196673 A1
(43) Pub. Date: Aug. 23, 2007

(54) Lubricative and protective thin film

(75) Inventors: Mehmet Hancer, Eagan, MN (US); John L. Brand, Burnsville, MN (US); Lance E. Stover, Eden Prairie, MN (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Seagate Technology LLC, Scotts Valley, CA (US)

(21) Appl. No.: 11/357,754

(22) Filed: Feb. 17, 2006

(51) Int. Cl. B32B 9/04

(52) U.S. Cl. 428/447; 428/446; 428/689; 428/698; 428/702

(57) ABSTRACT

The present invention is a lubricative and protective thin film often used within micro electromechanical systems. The film comprises an adhesion layer and a self-assembled monolayer, the self-assembled monolayer having a head group bonded to the adhesion layer and a tail group attached to the head group.

### BACKGROUND OF THE INVENTION

The present invention relates to coatings that protect and lubricate surfaces of microelectrical mechanical systems.

Layers within some micro electromechanical systems (for example disc drives) include a substrate, an adhesion layer, a magnetic layer, a diamond like carbon (DLC) protective layer, and a lubricant layer. The DLC protective layer, typically made of carbon and hydrogen, is a coating that is deposited on top of the magnetic layer creating an interface of intermixed magnetic layer molecules and DLC protective layer molecules between the two. The lubricant layer, typically polar bonded molecules, is deposited on top of the DLC layer creating another interface of intermixed DLC layer molecules and lubricant layer molecules.

The durability and reliability of magnetic media located within microelectrical mechanical systems is achieved primarily by the application of the DLC protective layer and the lubricant layer. The combination of the DLC protective layer and lubricant layer is referred to as a protective overcoat. The DLC protective layer is typically an amorphous film, which contains carbon and hydrogen and exhibits properties between those of graphite and diamond. Thin layers of DLC are deposited on discs using conventional thin film deposition techniques such as ion beam deposition (IBD), plasma enhanced chemical vapor deposition (PECVD), magnetron sputtering, radio frequency sputtering, or chemical vapor deposition (CVD).

During the deposition process, adjusting sputtering gas mixtures of argon and hydrogen varies the concentrations of hydrogen found in the DLC. Typical thicknesses of the DLC protective layer are around 20 to 80 Angstroms. The lubricant layer is typically deposited on top of the DLC protective layer, for added protection, lubrication, and enhanced disc drive reliability.

Typical lubricants used are perfluoropolyethers (PFPEs), which are long chain polymers composed of repeat units of small perfluorinated aliphatic oxides such as perfluoroethylene oxide or perfluoropropylene oxide. PFPEs are used as lubricants because they provide excellent lubricity, wide liquid-phase temperature range, low vapor pressure, small temperature dependency of viscosity, high thermal stability, and low chemical reactivity.

Depending on the ratio of bonded and non-bonded groups, the lubricant layer thickness can vary from about 10 Angstroms to about 50 Angstroms. The non-bonded portion of the lubricant facilitates lubrication while the bonded portion prevents DLC wear since it adsorbs onto the DLC film. The transducing head and media (i.e. a disc) DLC thickness, along with the lubricant thickness, are the biggest contributors of head media separation distance (HMSD). The HMSD in turn affects the data reading and writing efficiency of the head onto the media.

As a result of the demand for reduced HMSD, the thicknesses of the DLC and the lubricant layers has to be reduced to the smallest proportions possible. At these molecular thicknesses, the DLC and/or the lubricant can cease to perform its intended important function.

Therefore what is needed is a way to decrease the HMSD with a thinner film that can act as both a lubricant and a protector to the underlying substrate.

### BRIEF SUMMARY OF THE INVENTION

A lubricative and protective thin film often used within micro electromechanical systems. The film comprising an adhesion layer and a self-assembled monolayer, wherein the self-assembled monolayer comprises a head group bonded to the adhesion layer and a tail group attached to the head group.

### BRIEF DESCRIPTION OF THE DRAWINGS

FIG. 1 is a schematic representation of a lubricative and protective thin film according to one embodiment of the present invention.

FIG. 2 is a schematic representation of a single molecule of the lubricative and protective thin film.

FIG. 3 is a diagram illustrating a method of forming the lubricative and protective thin film.

FIG. 4A is perspective view of a disc drive containing various elements incorporating the lubricative and protective thin film.

FIG. 4B illustrates a first and a second lubricative and protective thin film on a surface of an adhesion layer and a slider, respectively.

### DETAILED DESCRIPTION

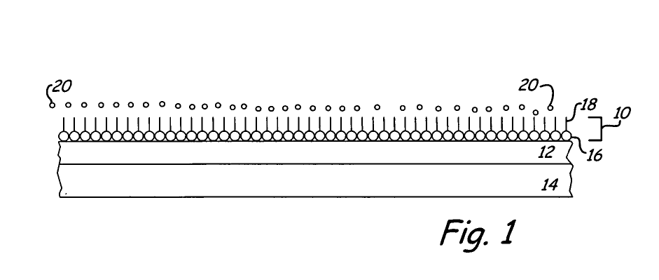

FIG. 1 is a schematic representation of a lubricative and protective thin film 10 on a surface of an adhesion layer 12 located on top of a substrate 14. Film 10 provides a lubricating and protecting thin film coating on adhesion layer 12. In one embodiment, film 10 is applied only to portions of adhesion layer 12. In other embodiments, the entirety of adhesion layer 12 is covered by film 10.

Film 10 has a thickness in a range of about 8 to about 25 Angstroms and tightly conforms to whatever surface it bonds to. Film 10 is shown bonded to adhesion layer 12. Adhesion layer 12 has a thickness in a range of about 5 to about 10 Angstroms. Adhesion layer 12 is shown deposited onto the surface of substrate 14. In other embodiments, film 10 can be deposited directly onto substrate 14. In one embodiment, substrate 14 can be any type of magnetic alloy, for example, nickel, iron, or cobalt. In other embodiments, substrate 14 may be any other type of element.

Film 10 can be sub-divided into a head group 16 and a tail group 18. Head group 16 is shown bonded to adhesion layer 12 and tail group 18 is shown interacting with lubricant layer 20 (illustrated as circles). As mentioned above, film 10 acts both as a protective film and a lubricating film. Therefore, lubricant layer 20 may be used in some embodiments to provide added lubrication, and in other embodiments lubricant layer 20 may be omitted altogether.

Traditionally, polar bonded lubricants had to be used because non-polar non-bonded lubricants would preferentially interact with the DLC layer and cause lubricant build-up on the slider. These polar bonded lubricants do not increase the disc lifetime and reliability as well as the non-polar non-bonded lubricants do. With the use of the present invention, however, these previously thought unusable non-polar non-bonded lubricants can be used because the DLC layer has been replaced with film 10, which has tail group 18 that does not preferentially react with non-polar non-bonded lubricants. In other embodiments, tail group 18 could be designed to preferentially react with lubricant layer 20, if so desired.

Lubricant layer 20, therefore, may be any type of substance (i.e. non-bonded, bonded, non-polar, or polar). In one embodiment, lubricant layer 20 is perfluoropolyether, hydrocarbon oil, helium gas, and combinations thereof. In other embodiments, lubricant layer 20 maybe other substances that are chosen to optimize performance and reliability of the micro electromechanical system.

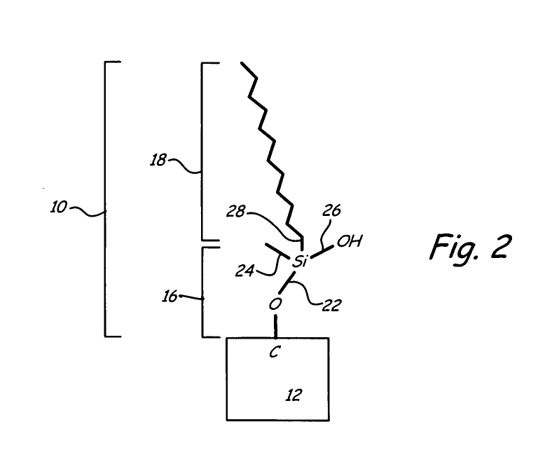

FIG. 2 is a schematic representation of a single molecule of film 10. The base group is a functional silane molecule. In other embodiments, the base group can be a functional thiol molecule. The functional silane molecule has four binding/bonding sites, denoted as 22, 24, 26, and 28. Sites 22, 24, and 26 are collectively known as head group 16 and site 28 is known as tail group 18. Within head group 16, site 22 represents the actual bonding connection between film 10 and adhesion layer 12. Sites 24 and 26 will either bind to an adjacent silane based molecule or will terminate in an OH group. In FIG. 2, site 24 is depicted as available to bind to an adjacent silane based molecule and site 26 is depicted as having a terminating OH group. In one embodiment, head group 16 is made from tridecafluoro-tetrahydrooctyl-trichlorosilane, heptadecafluoro-tetra-hydrodecyl-trichlorosilane, trichloro-silane, trimethoxy-silane, tri ethoxy-silane, dimethylaminosilane, octadecyltrichlorosilane, dodecyltricholorosilane, and combinations thereof. In other embodiments, head group 16 can be made from any silane or thiol based molecule.

Within tail group 18 is site 28, where the about 4 to about 20 carbon tail resides. Tail group 18 further comprises hydrocarbons, fluorocarbons, and combinations thereof In other embodiments, tail group 18 can comprise any halide or any carbon based molecule.

In one embodiment, adhesion layer 12 is selected from one of silicon, alumina, silicon nitride, silica, titanium carbide, metal oxide, and combinations thereof and has a thickness in a range of about 5 to about 10 Angstroms. In other embodiments, adhesion layer 12 can be any type of substance that will preferentially bind to head group 16 of film 10.

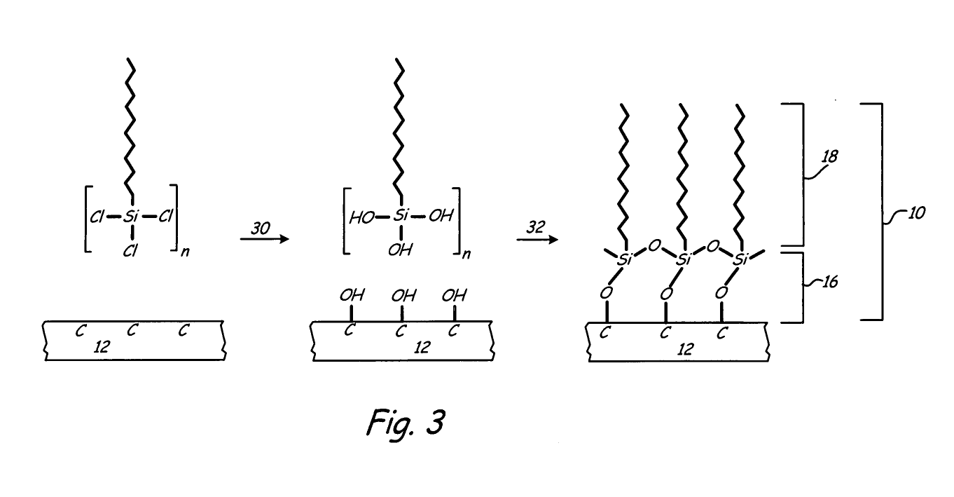

FIG. 3 is a diagram illustrating a method of forming film 10 onto adhesion layer 12. Film 10 of the present invention is a self-assembling monolayer thin film that is deposited onto adhesion layer 12 through at least one of molecular layer deposition, chemical vapor deposition, solution immersion, and combinations thereof. Molecular layer deposition and chemical vapor deposition occur through an atomization process, to form film 10, whereas solution immersion allows adhesion layer 12 to be fully or partially immersed into a solvent solution to form film 10.

First, the portions of adhesion layer 12 that are to be coated with film 10, and the film composition itself, are hydroxylated (represented as arrow 30). Next, adhesion layer 12 with the attached OH groups are exposed to the hydroxylated film composition through at least one of molecular layer deposition, chemical vapor deposition, solution immersion, and combinations thereof(all of which are represented by arrow 32). At this point, a monolayer of film 10 is bound to adhesion layer 12.

Whichever type of film deposition is used, film 10 will be self-assembling and cross-linking, meaning that a single functional silane molecule will automatically bind to an exposed OH group on adhesion layer 12 and then subsequently cross-link to two adjacent molecules that are bonded to two adjacent OH groups on adhesion layer 12. This allows film 10 to be self-assembled (thereby allowing for faster film deposition) and cross-linking (providing a stronger film).

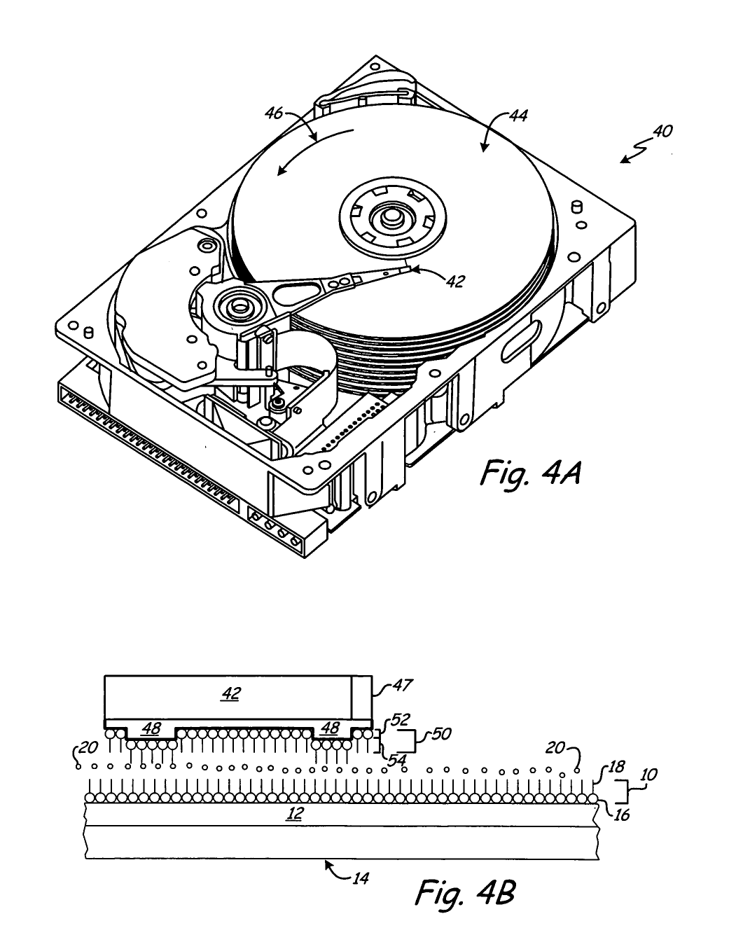

FIG. 4A is a perspective view of a disc drive 40. Disc drive 40 includes, among other elements, slider 42 and magnetic media disc 44. Slider 42 carries a transducing head (not shown in FIG. 4A) for reading and/or writing data on concentric tracks 46 of disc 44.

In one embodiment, the transducing head of slider 42 and the magnetic storage medium on disc 44 are fully or partially covered by film 10. In other embodiments, film 10 can be used to lubricate and protect any substrate having an adhesion layer.

FIG. 4B schematically illustrates two monolayers of the film of the present invention, coating slider 42 and adhesion layer 12. Adhesion layer 12 is located on top of substrate 14. In this embodiment, adhesion layer 12 is silicon and substrate 14 is nickel.

Film 10 is shown with head group 16 bonded to adhesion layer 12 and tail group 18 projected towards lubricant layer 20. Slider 42 is shown with transducing head 47. Adhesion layer 48 is located on the under surface of slider 42 and transducing head 47. Adhesion layer 48 has film 50 with its head group 52 and tail group 54. Film 50 has its tail group 54 projected towards lubricant layer 20. In one embodiment, films 10 and 50 are identical and in other embodiments, films 10 and 50 have different compositions.

Films 10 and 50 provide a lubricative and protective thin coating for slider 42, transducing head 47, and substrate 14, protecting them from corrosion and wear. The HMSD in FIG. 4B is much smaller than typical HMSDs found in the art because there is no DLC layer and films 10 and 50 are only about 8 Angstroms to about 25 Angstroms thick. This, along with the use of previously thought unusable lubricants, provides a better ultra thin protective lubricant film.

Although the present invention has been described with reference to preferred embodiments, workers skilled in the art will recognize that changes maybe made in form and detail without departing from the spirit and scope of the invention. For example, although described as being used in a disc drive, the lubricative and protective thin film can be used to advantage in other types of micro electromechanical systems.

1. A lubricative and protective thin film, the film comprising:
a substrate;
an adhesion layer on the substrate; and
a self-assembled monolayer on the adhesion layer, wherein the self-assembled monolayer comprises a head group bonded to the adhesion layer and a tail group attached to the head group.

2. The film of claim 1, wherein the adhesion layer that has a thickness in a range of about 5 to about 10 Angstroms.

3. The film of claim 1, wherein the adhesion layer is from a group consisting essentially of silicon, alumina, silicon nitride, silica, titanium carbide, metal oxide, and combinations thereof.

4. The film of claim 1, and further comprising:
a lubricant layer applied to the self-assembled monolayer, the lubricant layer having a thickness in a range of about 10 Angstroms to about 50 Angstroms.

5. The film of claim 4, wherein the lubricant layer comprises a non-polar, non-bonded substance.

6. The film of claim 4, wherein the lubricant layer is from a group consisting essentially of perfluoropolyether, hydrocarbon oil, helium gas, and combinations thereof.

7. The film of claim 1, wherein the self-assembled monolayer has a thickness in a range of about 8 to about 25 Angstroms.

8. The film of claim 1, wherein the head group comprises at least one of a functional silane molecule, and a functional thiol molecule.

9. The film of claim 8, wherein the head group is from a group consisting essentially of tridecafluoro-tetrahydrooctyl-trichlorosilane, heptadecafluoro-tetra-hydrodecyl-trichlorosilane, trichloro-silane, trimethoxy-silane, triethoxy-silane, dimethylaminosilane, octadecyltrichlorosilane, dodecyltricholorosilane, and combinations thereof.

10. The film of claim 1, wherein the tail group comprising from about 4 to about 20 carbons.

11. The film of claim 1, wherein the tail group comprises hydrocarbons, fluorocarbons, and combinations thereof.

12. An apparatus comprising:
first and second components that move relative to one another, the first component having a first surface and the second component having a second surface in close proximity to the first surface; and
a first self-assembled monolayer covering at least a portion of the first surface, wherein the first self-assembled monolayer comprises a head group with a tail group attached to the head group.

13. The apparatus of claim 12, wherein the first component is a slider and the second component is a media storage element, and wherein the second surface is at least partially covered by a second self-assembled monolayer that comprises a head group with a tail group attached to the head group.

14. The apparatus of claim 13, wherein a first adhesion layer is located between the first surface and the first self-assembled monolayer, and a second adhesion layer is located between the second surface and the second self-assembled monolayer, the adhesion layers having a thickness in a range of about 5 to about 10 Angstroms.

15. The apparatus of claim 13, wherein each of the first self-assembled monolayer and the second self-assembled monolayer has a thickness in a range of about 8 to about 25 Angstroms.

16. A method of providing a lubricative and protective thin film on a substrate, the method comprising:
forming an adhesion layer on the substrate; and
depositing a self-assembled monolayer onto the adhesion layer, wherein the self-assembled monolayer comprises a head group bonded to the adhesion layer and a tail group attached to the head group.

17. The method of claim 16, wherein the adhesion layer has a thickness in a range of about 5 to about 10 Angstroms.

18. The method of claim 16, wherein the self-assembled monolayer has a thickness in a range of about 8 to about 25 Angstroms.

19. The method of claim 16, wherein depositing the self-assembled monolayer onto the adhesion layer comprises at least one of molecular layer deposition, chemical vapor deposition, solution immersion, and combinations thereof.

20. The method of claim 16 and further comprising:
depositing a lubricant layer onto the self-assembled monolayer.
